(19) United States
(12) Patent Application Publication
(10) Pub. No.: US 2006/0048077 A1
(43) Pub. Date: Mar. 2, 2006

(54) Method, system, program product and user interface for displaying a topology

(75) Inventors: Ryan A. Boyles, Raleigh, NC (US); Joseph E. Firebaugh, Cary, NC (US); Robert C. Leah, Cary, NC (US)

Correspondence Address: HOFFMAN, WARNICK & D'ALESSANDRO LLC, 75 STATE ST, 14 FL, ALBANY, NY, 12207, US

(73) Assignee: International Business Machines Corporation, Armonk, NY (US)

(21) Appl. No.: 10/931,152

(22) Filed: Aug. 31, 2004

(51) Int. Cl. G06F 3/00

(52) U.S. Cl. 715/853; 715/734; 715/712; 715/713; 715/854; 715/855

(57) ABSTRACT

An improved solution for displaying a topology. A user can selectively adjust a baseline that is used to alter the emphasis of one or more topologic items for the topology. In response to an adjusted baseline, more or fewer topologic items can be displayed at full emphasis and/or de-emphasized. As a result, the user is allowed to dynamically select a desired emphasis level for viewing the topology.

### BACKGROUND OF THE INVENTION

1. Technical Field

The invention relates generally to displaying a topology. In particular, the invention provides a solution that enables a user to selectively alter the emphasis of one or more topologic items in the topology.

2. Background Art

One solution for viewing the status of a network or the like is the use of a topology view. Within the topology view, network resources (e.g., printer, router, computer, etc.), their relationships, and their current states (e.g., normal, critical, maintenance, etc.) can be displayed. Network management software such as Tivoli™ offered by International Business Machines Corp. of Armonk, N.Y., can be used to generate such a topology view.

The topology view provides several advantages over alternative views such as a table or the like for network resources. For example, a user can use the topology view of a network to determine important resources with critical failures (e.g., “what to work”). In particular, the relationship between various network resources, aggregated with status information, can be used to determine which resource failures most severely impact the performance of the overall network.

However, as the number of resources and resource states increases for a particular network, the topology view becomes unwieldy for a user. For example, a topology view generated using Tivoli™ can include hundreds of resources and their corresponding relationships for a particular network. Additionally, Tivoli™ specifies sixteen levels/values of resource states that can be indicated by displaying a decorator for each resource. As a result, it is often difficult for a user of a topology view to glance at large sets of resources to determine “what to work.” In this case, a user will frequently switch to use the table view or the like, which allows for better sorting and filtering capabilities. Consequently, much of the relationship information and potential benefit of using the topology view is lost.

To help alleviate some of these problems, the topology view is often customized based on an understood business or information technology practice tailored for the user's environment. In this case, the user can select to apply a pre-defined filter for displaying the topology view. However, this solution does not allow the user to dynamically tailor the topology view.

Similar problems exist in other types of topology views. For example, electronic maps are commonly used to portray directional information to a user. In particular, an efficient route from one location to another can be highlighted on a map. However, the map may include numerous details, such as secondary roads, landmarks, geographic area information, etc., that may be desired by some users, but are merely clutter for other users. As the map becomes more detailed e.g., due to a densely populated area that includes numerous secondary roads, landmarks, etc., the directional information becomes more difficult to ascertain.

As a result, a need exits for a solution that enables a user to dynamically tailor a topology view. In particular, a need exists for a method, system, program product, and user interface that allow a user to dynamically alter a baseline that is used to adjust the display of one or more topologic items in the topology view. In this manner, additional information can be dynamically emphasized or de-emphasized based on the current requirements of the user.

### SUMMARY OF THE INVENTION

The invention provides an improved solution for displaying a topology. Specifically, under the present invention, a user can selectively alter a baseline that is applied to one or more topologic items for the topology. In particular, the baseline is used to adjust an emphasis for each of the corresponding topologic items. As a result, the user can dynamically adjust the emphasis of one or more topologic items while viewing the topology.

A first aspect of the invention provides a method of displaying a topology, the method comprising: obtaining a default baseline for the topology; obtaining a set of emphasis criteria; applying the set of emphasis criteria to a topologic item for the topology, determining a default emphasis for the topologic item based on the set of emphasis criteria and the default baseline; and displaying the topologic item with the default emphasis.

A second aspect of the invention provides a method of displaying a topology, the method comprising: obtaining a set of emphasis criteria; applying the set of emphasis criteria to a topologic item for the topology, determining a default emphasis for the topologic item based on the set of emphasis criteria; displaying the topologic item with the default emphasis; receiving, a baseline selected by a user viewing the topology; generating an adjusted emphasis based on the baseline; and redisplaying the topologic item based on the adjusted emphasis.

A third aspect of the invention provides a system for displaying a topology, the system comprising: a criteria system that obtains a set of emphasis criteria; an emphasis system that applies the set of emphasis criteria to a topologic item for the topology and determines a default emphasis for the topologic item based on the set of emphasis criteria; a display system that displays the topologic item with the default emphasis; a baseline system that receives a baseline selected by a user viewing the topology; and an adjustment system that generates an adjusted emphasis based on the baseline, wherein the display system further redisplays the topologic item based on the adjusted emphasis.

A fourth aspect of the invention provides a user interface for displaying a topology, the user interface including: a display area for displaying a topologic item for the topology, wherein the topologic item has an emphasis that is based on a set of emphasis criteria and a default baseline; and a baseline selection area for enabling a user viewing the topology to adjust a baseline for the topology, wherein the topologic item is redisplayed based on the adjusted baseline.

A fifth aspect of the invention provides a program product stored on a recordable medium for displaying a topology, which when executed comprises: program code for obtaining a default baseline for the topology; program code for obtaining a set of emphasis criteria; program code for applying the set of emphasis criteria-to a topologic item for the topology; program code for determining a default emphasis for the topologic item based on the set of emphasis criteria and the default baseline; and program code for displaying the topologic item with the default emphasis.

A sixth aspect of the invention provides a system for deploying an application for displaying a topology, the system comprising: a computer infrastructure being operable to: obtain a set of emphasis criteria; apply the set of emphasis criteria to a topologic item for the topology and determines a default emphasis for the topologic item based on the set of emphasis criteria; display the topologic item with the default emphasis; receive a baseline selected by a user viewing the topology, generate an adjusted emphasis based on the baseline; and redisplay the topologic item based on the adjusted emphasis.

A seventh aspect of the invention provides computer software embodied in a propagated signal for displaying a topology, the computer software comprising instructions to cause a computer system to perform the following functions: obtain a default baseline for the topology; obtain a set of emphasis criteria; apply the set of emphasis criteria to a topologic item for the topology; determine a default emphasis for the topologic item based on the set of emphasis criteria and the default baseline; and display the topologic item with the default emphasis.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative system for displaying a topology,

FIG. 2 shows an illustrative user interface for displaying a topology;

FIG. 3 shows an alternative view of the illustrative user interface of FIG. 2;

FIG. 4 shows an alternative user interface for displaying a topology,

FIG. 5 shows an alternative view of the alternative user interface of FIG. 4; and

FIG. 6 shows an illustrative method flow according to one embodiment of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the invention provides an improved solution for displaying a topology. Specifically, under the present invention, a user can selectively alter a baseline that is applied to one or more topologic items for the topology. In particular, the baseline is used to adjust an emphasis for each of the corresponding topologic items. As a result, the user can dynamically adjust the emphasis of one or more topologic items while viewing the topology.

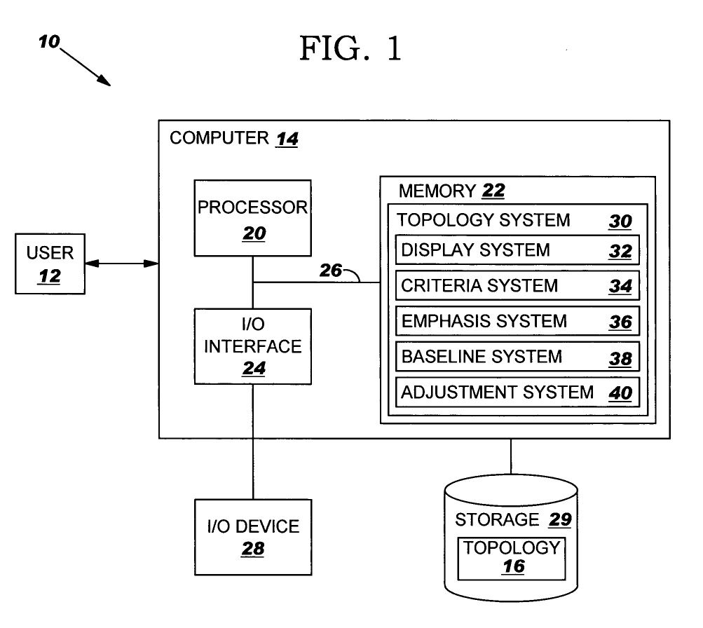

Turning to the drawings, FIG. 1 shows an illustrative system 10 for displaying a topology 16. In particular, a user 12 can operate computer 14 to access topology system 30, which displays topology 16. It is understood that topology 16 can comprise any data that describes a pattern of interconnection(s) between nodes. To this extent, topology 16 comprises a plurality of nodes and one or more connectors that each define a connection between two or more of the nodes. For example, topology 16 can comprise a network topology that describes various network attributes including the communications connectivity (interconnections) between various network resources such as printers, routers, computers, etc. (nodes). Further, topology 16 can comprise a map that describes the various roads (interconnections) between towns (nodes) for a given geographic area. Still further, topology 16 can comprise data that is stored in any type of hierarchical structure (e.g., a hierarchical tree) and is used for any purpose.

In any event, topology 16 can include additional network attributes regarding the connector(s), nodes, and/or the environment of the connector(s) and nodes. To this extent, topology 16 can include one or more information items. An information item can be associated with a connector and/or node, or it can be included in topology 16 apart from any connector or node. For example, when topology 16 comprises a network topology, topology 16 can include information items that describe a status and/or an importance of one or more communication connections and/or network resources. When topology 16 comprises a map, topology 16 can include information items such as points of interest, bodies of water, county/state boundaries, etc. Further, topology 16 can include information items for roads such as a type, distance, construction status, etc., and information items for towns such as size, capital, etc.

As noted previously, topology system 30 displays topology 16 to user 12. In one embodiment, topology system 30 is implemented on computer 14 as computer program code. For example, computer 14 can comprise any type of personal computer that is accessed and operated by user 12. To this extent, computer 14 is shown including a processor 20, a memory 22, an input/output (I/O) interface 24, and a bus 26. Further, computer 14 is shown in communication with an external I/O device/resource 28 and a storage system 29.

In general, processor 20 executes computer program code such as topology system 30, that is stored in memory 22 and/or storage system 29. While executing computer program code (e.g., topology system 30), processor 20 can read and/or write data (e.g., topology 16) to/from memory 22, storage system 29, and/or I/O interface 24. Bus 26 provides a communication link between each of the components in computer 14. User 14 interacts with computer 14 using one or more I/O devices 28 (e.g., keyboard, pointing device, display, etc.). It is understood, however, that if computer 14 comprises a handheld device or the like, one or more I/O devices 28 (e.g., a display) and/or storage system 29 could be contained within computer 14, not externally as shown.

Computer 14 is only illustrative of various possible combinations of hardware. For example, processor 20 may comprise a single processing unit, or be distributed across one or more processing units in one or more locations, e.g., on a client and server. Similarly, memory 22 and/or storage system 29 can comprise any combination of various types of data storage and/or transmission media that reside at one or more physical locations. I/O interface 24 can comprise any system for exchanging information with one or more I/O devices 28 that provide an interface with one or more other computing devices and/or users 12.

Further, user 12 could operate another computing device (not shown) that communicates with computer 14 over a network (also not shown) using I/O device 28 (e.g., network adapter, I/O port, modem, etc.). In this case, the network can comprise any type of communications link. For example, the network can comprise an addressable connection in a client-server (or server-server) environment that may utilize any combination of wireline and/or wireless transmission methods. Further, the network can comprise any combination of various types of networks, including the Internet, a wide area network (WAN), a local area network (LAN), a virtual private network (VPN), etc. Regardless, connectivity and communications between the various computing devices can be implemented using any known protocol(s).

In any event, topology system 30 can display topologic items for topology 16. Each topologic item comprises a visual representation for a connector, node, and/or information item that is included in topology 16. To this extent, topology system 30 is shown including a display system 32 that displays one or more topologic items for topology 16, a criteria system 34 that obtains a set of emphasis criteria for topology 16, an emphasis system 36 that determines an emphasis for one or more topologic items, a baseline system 38 that receives a baseline selected by user 12, and an adjustment system 40 that generates an adjusted emphasis based on the baseline. Operation of each of these systems is described further below. However, it is understood that some of the various systems shown in FIG. 1 can be implemented independently, combined, and/or stored in memory for one or more separate computers 14 that communicate over a network. Further, it is understood that some of the systems and/or functionality may not be implemented, or additional systems and/or functionality may be included as part of system 10.

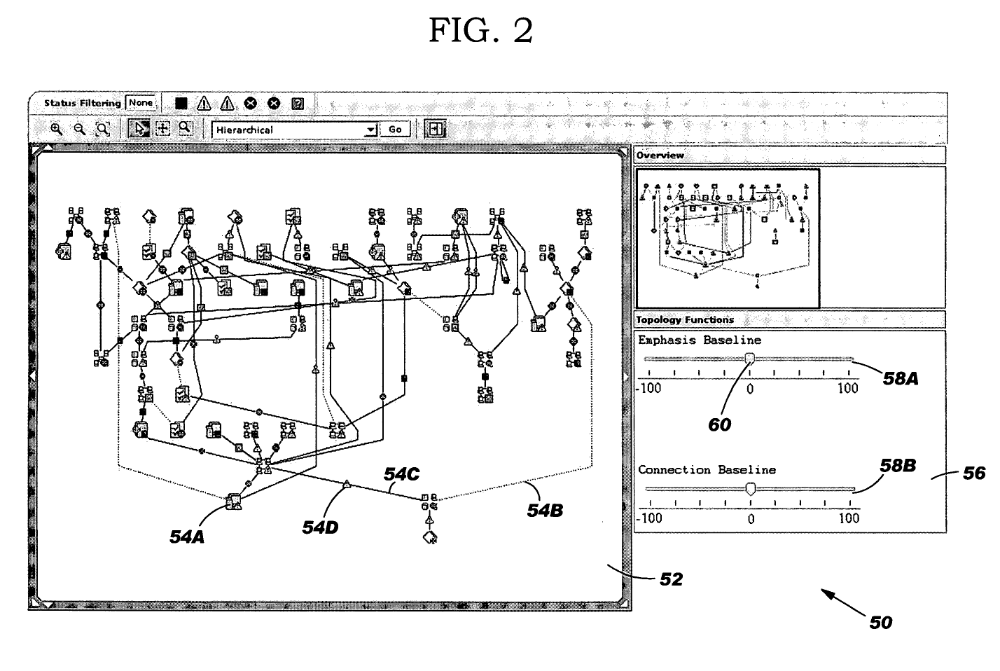

Additional aspects of the invention are now discussed with reference to FIGS. 1 and 2. FIG. 2 shows an illustrative user interface 50 for displaying topology 16 FIG. 1) that can be generated by display system 32. As shown, topology 16 can comprise a network topology, and user interface 50 can include a display area 52 that displays various topologic items 54A-D that visually represent a network resource (topologic item 54A), connections (topologic items 54B-C), and status information (topologic item 54D). In one embodiment, display system 32 can obtain the set of topologic items 54A-D from topology 16. In particular, topology 16 can define the topologic item 54A-D that visually represents each network attribute in topology 16. Alternatively, the set of topologic items 54A-D can be stored and separately maintained apart from topology 16 and can be matched with the corresponding network attributes in topology 16 to generate display area 52.

In order to generate the content of display area 52, criteria system 34 can further obtain a set of emphasis criteria. The set of emphasis criteria can enable display system 32 to alter the appearance of one or more topologic items 54A-D in display area 52. For the illustrative network topology shown in FIG. 2, the set of emphasis criteria can include an importance for each topologic item 54A-D and a status of each topologic item 54A-D. The importance and/or status of each topologic item 54A-D can be dynamically determined based on static and/or dynamic properties of the corresponding data in topology 16. For example, one or more dynamic properties of a network resource such as its current workload, user(s) present, error status, etc., could be used to obtain an importance and/or status for the corresponding topologic item 54A-D. In any event, criteria system 34 can provide the set of emphasis criteria to emphasis system 36 for use in generating the content of display area 52.

In one embodiment, the set of emphasis criteria is stored in and obtained from topology 16. In this case, the set of emphasis criteria and/or resource properties can be dynamically updated by a network administrator, network monitoring software and the like to reflect the current properties, status and/or importance of the various network resources. However, the set of emphasis criteria can also be obtained based on user 12. For example, user 12 could comprise a network administrator that wants to focus on a particular subset of the entire network shown in display area 52. In this case, the set of emphasis criteria could assign the highest importance to the various topologic items 54A-D that correspond to the particular subset. Alternatively, user 12 could comprise a technical support individual that interfaces with the end users of the network. In this case, network resources such as personal computers and printers could be assigned the highest importance by the set of emphasis criteria. In any event, it is understood that criteria system 34 could obtain some or all of the set of emphasis criteria automatically (e.g., from topology 16) and/or via a user interface or the like that enable each user 12 to selectively alter the set of emphasis criteria for his/her use.

As noted previously, criteria system 34 can provide the set of emphasis criteria to emphasis system 36 for use in generating the content of display area 52. In particular, emphasis system 36 can apply the set of emphasis criteria to each topologic item 54A-D for topology 16 in order to generate the content of display area 52. In one embodiment, emphasis system 36 can determine a status for various topologic items 54A-C based on the set of emphasis criteria, and emphasis system 36 can add additional topologic items (e.g., topologic item 54D) to be displayed by display system 32 in display area 52. Similarly, an importance for various topologic items 54A-D can be determined based on the set of emphasis criteria. As discussed above, the importance can be based on the importance of the corresponding network resource and/or the importance of the particular network resource to users 12. In this case, display system 32 can alter the display of similar topologic items, such as topologic items 54B-C, based on the relative importance of the corresponding connections.

In any event, emphasis system 36 can determine a default emphasis for each topologic item 54A-D based on the set of emphasis criteria. In one embodiment, the default emphasis can be represented as a value between zero and one hundred percent opacity. In this case, an opacity can be assigned to each type of network resource, the status of the network resource, and/or the importance of the resource. For example, a printer resource may have a relatively low importance and be assigned an opacity often percent, while a router resource may have a relatively high importance and be assigned an opacity of forty percent. Further, a normal status may be assigned an opacity of zero percent, a warning status an opacity of twenty percent, and a critical status an opacity of forty percent. To determine the default emphasis, the opacities assigned to the importance and status for each resource can be summed. In this case, a printer having a normal status would be assigned an opacity of ten percent (ten percent for importance plus zero percent for normal status), while a router having a warning status would be assigned an opacity of sixty percent (forty percent for importance plus twenty percent for warning status).

Emphasis system 36 can provide the default emphasis for each topologic item 54A-D to display system 32, which can render each topologic item 54A-D with the default emphasis in display area 52 using any known solution. For example, topologic item 54C is shown as a solid line while topologic item 54B is shown as a dashed line. In this case, topologic item 54C can have a higher default emphasis (e.g., opacity) than topologic item 54B. It is understood that various alternatives can be used in conjunction with or alternative to opacity. For example, the color, brightness, size, etc. of topologic items 54A-D can be altered based on the default emphasis.

The invention further provides a user-selectable baseline that can be used to generate the content of display area 52. In one embodiment, baseline system 38 can obtain a default baseline that is used to generate the display for topology 16 and provide the default baseline to emphasis system 38 for use in determining the default emphasis. The baseline comprises an alteration that is applied to the emphasis that is determined based on the status information for one or more topologic items 54A-D. To this extent, the baseline can be used to add and/or subtract from the emphasis for one or more topologic items 54A-D. In one embodiment, the same baseline can be applied to all topologic items 54A-D that are displayed in display area 52. In addition to or alternative to a single baseline, a plurality of baselines that are applied to topologic items 54A-D that share a common attribute can be used. For example, a baseline can be provided for one or more types of network resources (e.g., printer, router, connection, etc.), network resources in a particular geographic location (e.g., offices at Armonk, N.Y.), and the like.

In any event, emphasis system 36 can adjust the emphasis for each topologic item 54A-D based on the baseline(s) for the corresponding network resource. For example, as discussed above, the emphasis can comprise a percent opacity with which the topologic item 54A-D is to be rendered (displayed). In this case, baseline system 38 can obtain a default baseline that also comprises a percent opacity, and emphasis system 36 can add the baseline percent opacity to the percent opacity that is determined based on the set of emphasis criteria (e.g., importance, status).

When the emphasis can have a value within a predefined range of values (e.g., a percentage ranging between zero and one hundred percent), emphasis system 36 may need to adjust the calculated emphasis to a value within the predefined range of values. For example, continuing with the example discussed above, the calculation of an emphasis for a router (forty percent opacity) having a critical status (forty percent opacity) with a baseline of fifty percent would yield an opacity of one hundred ten percent. In this case, emphasis system 36 could adjust the opacity to one hundred percent. As a result, the baseline can enable additional topologic items 54A-D to be displayed at full opacity, thereby effectively adding topologic items 54A-D to a set of topologic items that are fully emphasized within display area 52.

User 12 can selectively alter the baseline(s) for a topology 16 while viewing the topology in display area 52. To this extent, baseline system 38 can receive an adjusted baseline for topology 16 that is selected by user 12. User 12 can specify the baseline using any known solution. For example, user interface 50 is further shown including a baseline selection area 56 that enables user 12 to adjust two baselines. In particular, baseline system 38 can display two slider bars 58A-B, each having a slider 60 initially positioned at a location that corresponds to a default baseline (e.g., zero). In this case, slider bar 58A can enable user 12 to selectively adjust a baseline that is applied to all topologic items 54A-D displayed in display area 52, while slider bar 58B can enable user 12 to selectively adjust a baseline that is applied to each topologic item 54B-C that corresponds to a connection. In any event, each slider bar 58A-B can comprise various locations that correspond to different baseline values (e.g., negative one hundred to one hundred percent). Baseline system 38 can receive a user command generated by user 12 to move slider 60 to a new location on slider bar 58A, and determine the adjusted baseline based on the new location in a known fashion.

Baseline system 38 can provide the adjusted baseline to adjustment system 40, which can generate an adjusted emphasis for one or more topologic items 54A-D based on the adjusted baseline. In particular, adjustment system 40 can obtain from emphasis system 36 an emphasis that was calculated based on the set of emphasis criteria for each topologic item 54A-D that corresponds to the adjusted baseline. Subsequently, adjustment system 40 can adjust the emphasis using the adjusted baseline. For example, when the emphasis and baseline comprise an opacity, adjustment system 40 can add the adjusted baseline to the emphasis to determine an opacity and, if necessary, adjust the value to fall within an acceptable range of values for the opacity.

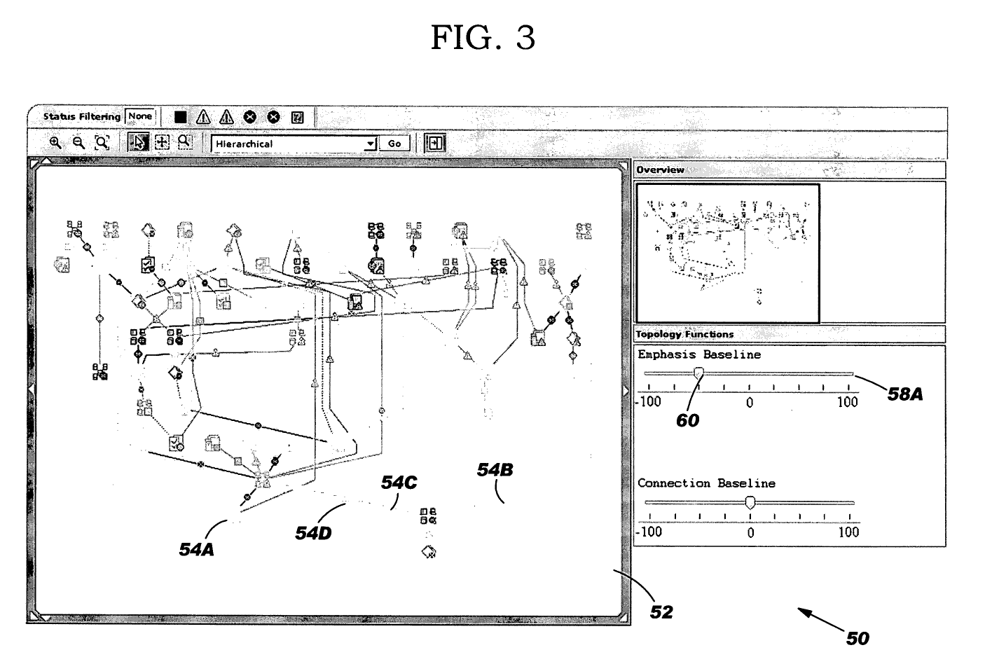

Subsequently, display system 32 can redisplay each topologic item 54A-D based on the adjusted baseline. In particular, adjustment system 40 can provide the adjusted emphasis to display system 32 which can render the corresponding topologic item 54A-D with the adjusted emphasis. For example, as shown in FIG. 3, user 12 could move slider 60 on slider bar 58A to a new location In response, baseline system 38 can determine an adjusted baseline (e.g., negative fifty percent) based on the new location, and provide the adjusted baseline to adjustment system 40. Adjustment system 40 can determine an adjusted emphasis based on the adjusted baseline, and display system 32 can redisplay each topologic item 54A-D in display area 52 with the adjusted emphasis.

As a result, the invention enables user 12 to dynamically select a desired level of emphasis for one or more topologic items 54A-D when viewing topology 16. It is understood that various additional functions can be provided to user 12 to further customize a view of topology 16. For example, as shown in FIGS. 2 and 3, user 12 can select to filter (e.g., remove) topologic items 54A-D based on their corresponding status (e.g., normal, warning, critical). Further, user 12 can zoom in/out to particular areas of topology 16 and the like. Still further, while the baseline has been shown and described as being added/subtracted to an emphasis, it is understood that the baseline can be implemented in any fashion. For example, the baseline could comprise a multiplier that is applied to the emphasis.

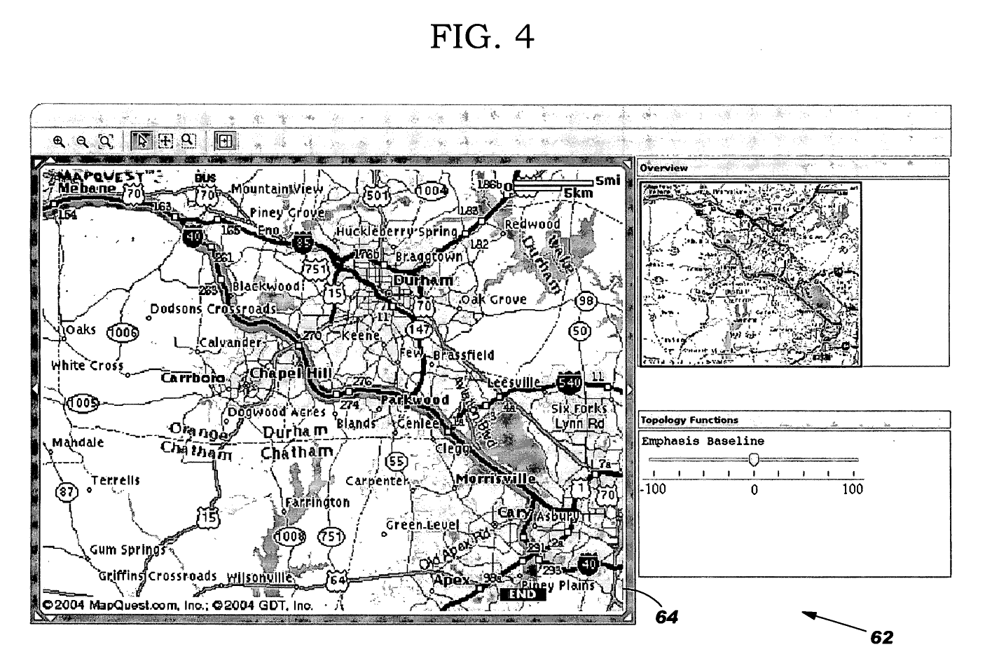

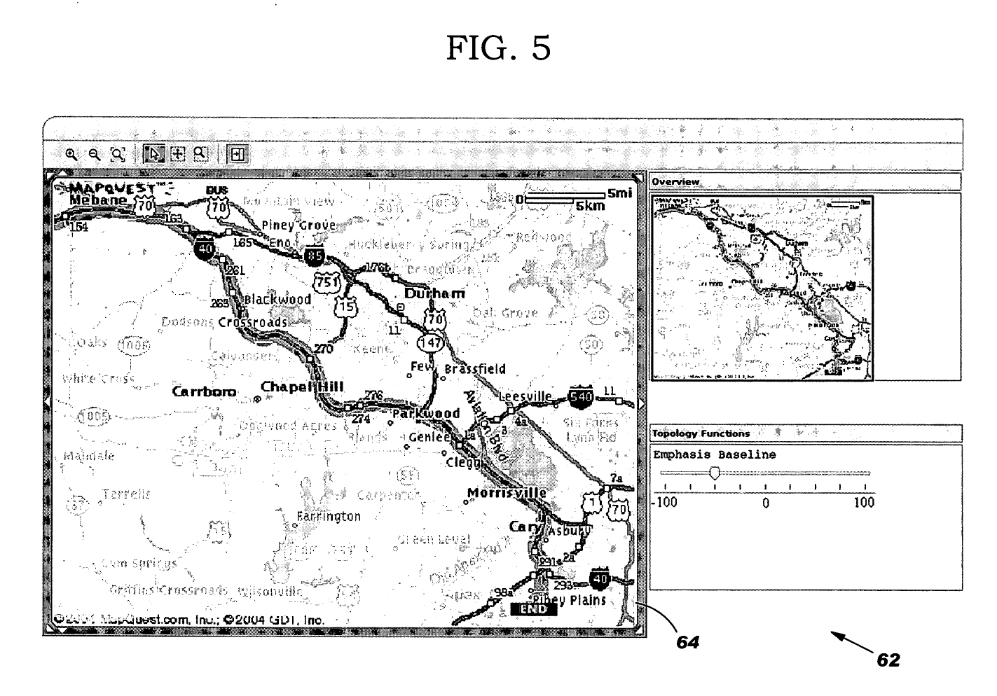

While the invention has been shown and described primarily with reference to a network topology, it is understood that the teachings of the invention are not limited to this application. For example, FIG. 4 shows an alternative interface 62 for displaying directions to user 12 (FIG. 1) using a map 64. As is known, the suggested route can be highlighted or otherwise indicated on map 64. However, the various topologic items that correspond to bodies of water, counties, towns, etc., can make it difficult for user 12 to readily determine the suggested route indicated on map 64. As a result, as shown in FIG. 5, user 12 can alter a baseline for map 64, and the various topologic items can be redisplayed with an adjusted emphasis. In this case, the emphasis for various topologic items located further from the suggested route can be de-emphasized, making it easier for user 12 to locate information that is more likely to be required along the suggested route.

It is understood that the teachings of the invention can be applied to various graphical depictions. For example, in addition to systems management and mapping views, the invention can be applied to blueprint software, computer-aided design software, etc. In general, the teachings of the invention can be applied to any graphical interface that depicts information of varied levels of importance combined with varied levels of status. However, it is understood that alternative and/or additional attributes of topologic items can be used to determine various levels of emphasis, such as location information, time information (e.g., how long a network resource been in a critical state), etc.

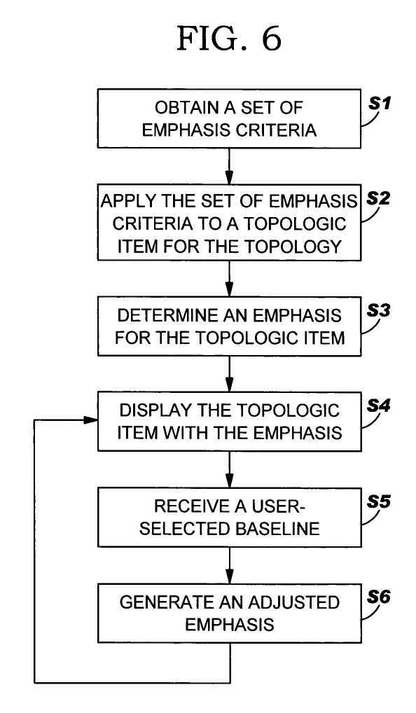

The invention further includes a method of displaying topology 16 (FIG. 1). FIG. 6 shows an illustrative method flow according to one embodiment of the invention. In step S1, a set of emphasis criteria is obtained, and in step S2, the set of emphasis criteria is applied to a topologic item for the topology. In step S3, an emphasis is determined based on the set of emphasis criteria and/or a default baseline for the topology. In step S4, the topologic item is displayed with the emphasis. In step S5, a user-selected baseline is received, and in step S6, an adjusted emphasis is generated based on the user-selected baseline. Subsequently, the method returns to step S4 to redisplay the topologic item with the adjusted emphasis. Steps S4-S6 can be repeated after each modification to a baseline by the user.

Still yet, it should be appreciated that the teachings of the present invention could be offered as a business method on a subscription or fee basis. For example, topology system 30 (FIG. 1) could be created, maintained and/or deployed by a service provider that offers the functions described herein for customers. That is, a service provider could offer to display topology 16 (FIG. 1) as described above. It is understood that the present invention can be realized in hardware, software, a propagated signal, or any combination thereof. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized.

The present invention also can be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of displaying a topology, the method comprising:
obtaining a default baseline for the topology;
obtaining a set of emphasis criteria;
applying the set of emphasis criteria to a topologic item for the topology;
determining a default emphasis for the topologic item based on the set of emphasis criteria and the default baseline; and
displaying the topologic item with the default emphasis.

2. The method of claim 1, wherein the topologic item comprises a visual representation of one of a node, a connector and an information item.

3. The method of claim 1, wherein the set of emphasis criteria includes an importance factor for the topologic item and a status of the topologic item.

4. The method of claim 1, further comprising:
receiving an adjusted baseline for the topology;
generating an adjusted emphasis based on the adjusted baseline; and
displaying the topologic item with the adjusted emphasis.

5. The method of claim 4, wherein the receiving step includes:
displaying a slider bar having a slider positioned at a location that corresponds to the default baseline;
receiving a user command to move the slider to a new location on the slider bar; and
determining the adjusted baseline based on the new location.

6. The method of claim 1, wherein the topology comprises a network topology.

7. The method of claim 1, wherein the determining a default emphasis step includes:
determining a first emphasis for the topologic item based on an importance in the set of emphasis criteria; and
adding the default baseline to the first emphasis to obtain the default emphasis.

8. The method of claim 7, wherein the determining a default emphasis step further includes adjusting the default emphasis to a value in a predefined range of values.

9. A method of displaying a topology, the method comprising:
obtaining a set of emphasis criteria;
applying the set of emphasis criteria to a topologic item for the topology;
determining a default emphasis for the topologic item based on the set of emphasis criteria;
displaying the topologic item with the default emphasis;
receiving a baseline selected by a user viewing the topology;
generating an adjusted emphasis based on the baseline; and
redisplaying the topologic item based on the adjusted emphasis.

10. The method of claim 9, further comprising obtaining a default baseline for the topology, wherein the default emphasis is further based on the default baseline.

11. The method of claim 9, wherein the determining step includes determining a first emphasis for the topologic item based on an importance in the set of emphasis criteria.

12. The method of claim 11, wherein the generating step includes adding the baseline to the first emphasis to obtain the adjusted emphasis for the topologic item.

13. The method of claim 9, wherein the receiving step includes:
displaying a slider bar having a slider; and
receiving a user command to move the slider to a new location on the slider bar; and
determining the baseline based on the new location.

14. A system for displaying a topology, the system comprising:
a criteria system that obtains a set of emphasis criteria;
an emphasis system that applies the set of emphasis criteria to a topologic item for the topology and determines a default emphasis for the topologic item based on the set of emphasis criteria;
a display system that displays the topologic item with the default emphasis;
a baseline system that receives a baseline selected by a user viewing the topology; and
an adjustment system that generates an adjusted emphasis based on the baseline, wherein the display system further redisplays the topologic item based on the adjusted emphasis.

15. The system of claim 14, wherein the baseline system further obtains a default baseline for the topology, and wherein the default emphasis is further based on the default baseline.

16. The system of claim 14, wherein the baseline system displays a slider bar having a slider; receives a user command to move the slider to a new location on the slider bar; and determines the baseline based on the new location.

17. A user interface for displaying a topology, the user interface including:
a display area for displaying a topologic item for the topology, wherein the topologic item has an emphasis that is based on a set of emphasis criteria and a default baseline; and
a baseline selection area for enabling a user viewing the topology to adjust a baseline for the topology, wherein the topologic item is redisplayed based on the adjusted baseline.

18. The user interface of claim 17, wherein the baseline selection area comprises a slider bar having a slider, and wherein the user moves the slider to one of a plurality of locations on the slider bar to adjust the baseline.

19. The user interface of claim 17, wherein the topology comprises a network topology.

20. A program product stored on a recordable medium for displaying a topology, which when executed comprises:
program code for obtaining a default baseline for the topology;
program code for obtaining a set of emphasis criteria;
program code for applying the set of emphasis criteria to a topologic item for the topology;
program code for determining a default emphasis for the topologic item based on the set of emphasis criteria and the default baseline; and
program code for displaying the topologic item with the default emphasis.

21. The program product of claim 20, wherein the program code for determining includes:
program code for determining a first emphasis for the topologic item based on an importance in the set of emphasis criteria; and
program code for adding the default baseline to the first emphasis to obtain the default emphasis.

22. The program product of claim 21, wherein the program code for determining further includes program code for adjusting the default emphasis to a value in a predefined range of values.

23. The program product of claim 20, further comprising:
program code for receiving an adjusted baseline for the topology;
program code for generating an adjusted emphasis based on the adjusted baseline; and
program code for displaying the topologic item with the adjusted emphasis.

24. The program product of claim 23, wherein the program code for receiving includes:
program code for displaying a slider bar having a slider positioned at a location that corresponds to the baseline;
program code for receiving a user command to move the slider to a new location on the slider bar; and
program code for determining the adjusted baseline based on the new location.

25. A system for deploying an application for displaying a topology, the system comprising:
a computer infrastructure being operable to:
obtain a set of emphasis criteria;
apply the set of emphasis criteria to a topologic item for the topology and determines a default emphasis for the topologic item based on the set of emphasis criteria;
display the topologic item with the default emphasis;
receive a baseline selected by a user viewing the topology;
generate an adjusted emphasis based on the baseline; and
redisplay the topologic item based on the adjusted emphasis.

26. Computer software embodied in a propagated signal for displaying a topology, the computer software comprising instructions to cause a computer system to perform the following functions:
obtain a default baseline for the topology;
obtain a set of emphasis criteria;
apply the set of emphasis criteria to a topologic item for the topology;
determine a default emphasis for the topologic item based on the set of emphasis criteria and the default baseline; and
display the topologic item with the default emphasis.

27. The computer software of claim 26, further comprising instructions to:
receive an adjusted baseline for the topology;
generate an adjusted emphasis based on the adjusted baseline; and
display the topologic item with the adjusted emphasis.
